(19) United States
(12) Patent Application Publication
(10) Pub. No.: US 2008/0077267 A1
(43) Pub. Date: Mar. 27, 2008

(54) CONTROLLING SYSTEM FOR CARDBOARD-SHEET MANUFACTURING APPARATUS

(75) Inventors: Hiroshi ISHIBUCHI, Hiroshima-ken (JP); Tsunehiro Kawashima, Hiroshima-ken (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., TOKYO (JP)

(21) Appl. No.: 11/859,671

(22) Filed: Sep. 21, 2007

(30) Foreign Application Priority Data
Sep. 22, 2006 (JP) 2006-257464

(51) Int. Cl. G06F 19/00

(52) U.S. Cl. 700/112; 700/30; 700/48; 700/89

(57) ABSTRACT

A controlling system for a cardboard-sheet manufacturing apparatus includes an FF/FB controlling unit, a PID controller, and a knowledge database. The FF/FB controlling unit differentiates between compensation for a dynamic characteristic and that for a static characteristic based on the knowledge database, and switches between FF control and FB control. The PID controller operates based on a two-degree-of-freedom PID algorithm. The FF/FB controlling unit adjusts a feedback gain based on information stored in the knowledge database.

### BACKGROUND OF THE INVENTION

1. Field of the Invention

The present invention relates to a technology for manufacturing of cardboard sheets.

2. Description of the Related Art

Proportional-integral-derivative (PID) control, often called feedback control, is a control mode for controlling parameters such as temperature and pressure. The PID control is a three-term control having a proportional term (P), an integral term (I), and a derivative term (D), which are adjusted to improve control characteristics. Japanese Patent Application Laid-Open No. 2003-195905 discloses a conventional technology in which PID control parameters are derived based on a PID control algorithm and a model-predicting algorithm.

In the process of manufacturing a cardboard sheet, the quality of the manufactured cardboard sheet is affected by temperature or moisture content of a base sheet or a single-faced cardboard sheet at an adhering step. For the purpose of controlling the temperature or the moisture content, a method known as “matrix control” is often used. In the matrix control, a matrix table of operating conditions is prepared in advance, and before manufacturing a cardboard sheet, certain conditions are selected from the matrix table and adjusted based on manufacturing conditioning information (composition or basis weight of a base sheet, sheet width, etc.) input to a manufacturing management apparatus, and operating information of a cardboard-sheet manufacturing apparatus (operation speed, amount of sheet wound around a preheater, etc.) to reduce defective adhesion or warping of the cardboard sheet.

Because the operating conditions in the matrix control are prepared based on experience and intuition of operators, such operating conditions are roughly set, and fine exact adjustment thereof has been difficult. According to the conventional technology, the PID feedback control is applied to maintain temperature or moisture content of the base sheet or the single-faced cardboard sheet at an adhering step to the target value, so that warping or defective adhesion of the cardboard sheet can be reduced compared with the case of using the matrix control alone. Although less control time is required to manufacture cardboard sheets at a high speed, the control time increases with the conventional technology alone, which impedes accurate control of the cardboard quality.

### SUMMARY OF THE INVENTION

It is an object of the present invention to at least partially solve the problems in the conventional technology.

According to an aspect of the present invention, a controlling system for a cardboard-sheet manufacturing apparatus includes a first control unit that performs at least one of feedforward control and feedback control for manufacturing of a cardboard sheet to control at least one of temperature and moisture content of the cardboard sheet in process to a target value; an information providing unit that stores therein information on evaluation of the cardboard sheet manufactured, information on any one of the temperature and the moisture content of the cardboard sheet in process, and information related to the manufacturing of the cardboard sheet in an associated manner; and a second control unit that changes control parameters of the feedforward control and the feedback control based on the information stored in the information providing unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a cardboard-sheet manufacturing apparatus that is controlled by a controlling system according to a first embodiment of the present invention;

FIGS. 2 and 3 are schematic diagrams of examples of a single facer shown in FIG. 1;

FIG. 4 is a schematic diagram of one example of a set of preheaters shown in FIG. 1;

FIG. 5 is a schematic diagram of one example of a glue machine shown in FIG. 1;

FIG. 6 is a schematic diagram of one example of a double facer shown in FIG. 1;

FIG. 7 is a schematic diagram for explaining sheet-temperature control performed by the controlling system according to the first embodiment;

FIG. 8 is a flowchart of a cardboard-sheet manufacturing process performed by the controlling system according to the first embodiment;

FIG. 9 is a schematic diagram for explaining a method for evaluating warpage of a finished double-faced cardboard sheet;

FIGS. 10 and 11 are examples of display screens of the controlling system according to the first embodiment;

FIG. 12 is a schematic diagram for explaining sheet-temperature control performed by a controlling system for a cardboard-sheet manufacturing apparatus according to a second embodiment of the present invention;

FIG. 13 is a schematic diagram for explaining sheet-temperature control performed by a controlling system for a cardboard-sheet manufacturing apparatus according to a modification of the second embodiment; and

FIG. 14 is a schematic diagram for explaining sheet-temperature control performed by a controlling system for a cardboard-sheet manufacturing apparatus according to a third embodiment of the present invention.

### DETAILED DESCRIPTION OF THE PREFERRED EMBODIMENTS

Exemplary embodiments of the present invention are explained in detail below with reference to the accompanying drawings. It is noted that the terms “front” and “rear” as used herein do not refer to a specific side or direction, but for the convenience of explanation. These terms are relative to each other; “front” indicates the opposite of “rear”, and vice versa. In the following description, in-process cardboard sheet including a base sheet, a front liner, a rear liner, and a single-faced cardboard sheet (corrugating medium adhered with only one of the liners) are sometimes simply referred to as “sheet” as required.

According to a first embodiment of the present invention, a controlling system for a cardboard-sheet manufacturing apparatus switches feedforward (FF) control and feedback (FB) control to control at least one of temperature and moisture content of a cardboard sheet based on control information about the cardboard-sheet manufacturing apparatus provided from an information providing unit. The information providing unit establishes an association among evaluation information of a manufactured cardboard sheet, temperature or moisture content information of the in-process sheet (base sheet or single-faced cardboard sheet), and manufacturing-related information at the time the cardboard sheet is being manufactured, and provides associated information to the controlling system. The information providing unit is realized, for example, as a knowledge database, a fieldbus, or a neural network.

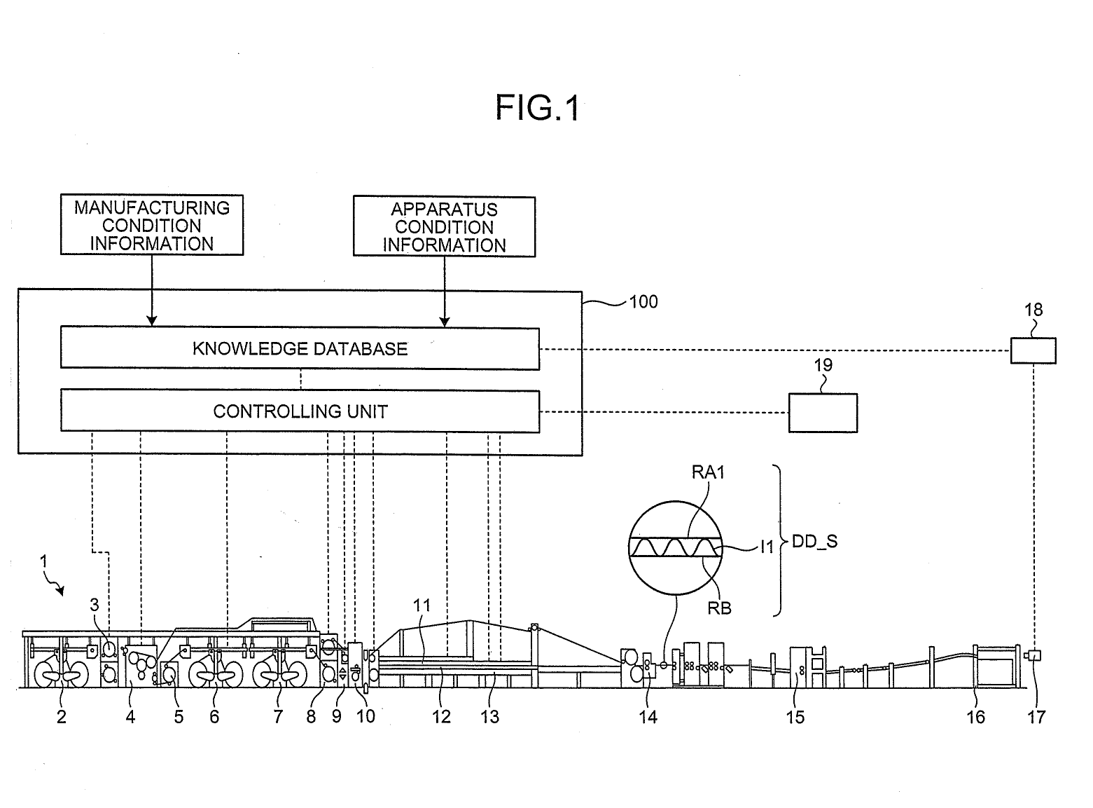

FIG. 1 is a schematic diagram of a cardboard-sheet manufacturing apparatus 1 that is controlled by the controlling system 100 according to the first embodiment. The cardboard-sheet manufacturing apparatus 1 include a rear liner mill roll stand 2, a rear liner preheater 3, a single facer 4, a medium preheater 5, a medium mill roll stand 6, a front liner mill roll stand 7, a set of preheaters 8, a shower unit 9, a glue machine 10, a double facer 13 further including a pressing unit 11 and a heating plate 12, a rotary shear 14, and a cutoff unit 15, and a double-faced cardboard sheet storage unit 16.

The single facer 4 glues a corrugating medium I1 to a rear liner RA1 to form a single-faced cardboard sheet DS_S, which, in turn, is glued to the front liner RB by the glue machine 10. The single-faced cardboard sheet DS_S and the front liner RB are pressed and heated in the double facer 13, and a finished double-faced cardboard sheet DD_S is manufactured.

The controlling system 100 includes a knowledge database and controlling unit. The cardboard-sheet manufacturing apparatus 1 further includes a camera 17 as an imaging unit at the double-faced cardboard sheet storage unit 16, thereby detecting warpage in the finished double-faced cardboard sheet DD_S. Conditions of the double-faced cardboard sheet DD_S, photographed by the camera 17, are analyzed in an image processing/evaluating unit 18, and collected by the controlling system 100 in the cardboard.

The controlling system 100 is connected to an image displaying unit 19 that displays the conditions of the double-faced cardboard sheet DD_S photographed by the camera 17. The conditions of the double-faced cardboard sheet DD_S, which is photographed by the camera 17, is accumulated in a knowledge database 103 and used by the controlling system 100 to control the cardboard-sheet manufacturing apparatus 1. Although only the camera 17 is shown in FIG. 1 as an imaging unit that detects the warpage of the finished double-faced cardboard sheet DD_S, other imaging units can also be provided, such as those for detecting certain conditions of in-process base sheet, or the certain condition of the single-faced cardboard sheet in the cardboard-sheet manufacturing apparatus 1. The structural units of the cardboard-sheet manufacturing apparatus 1 are described in details below.

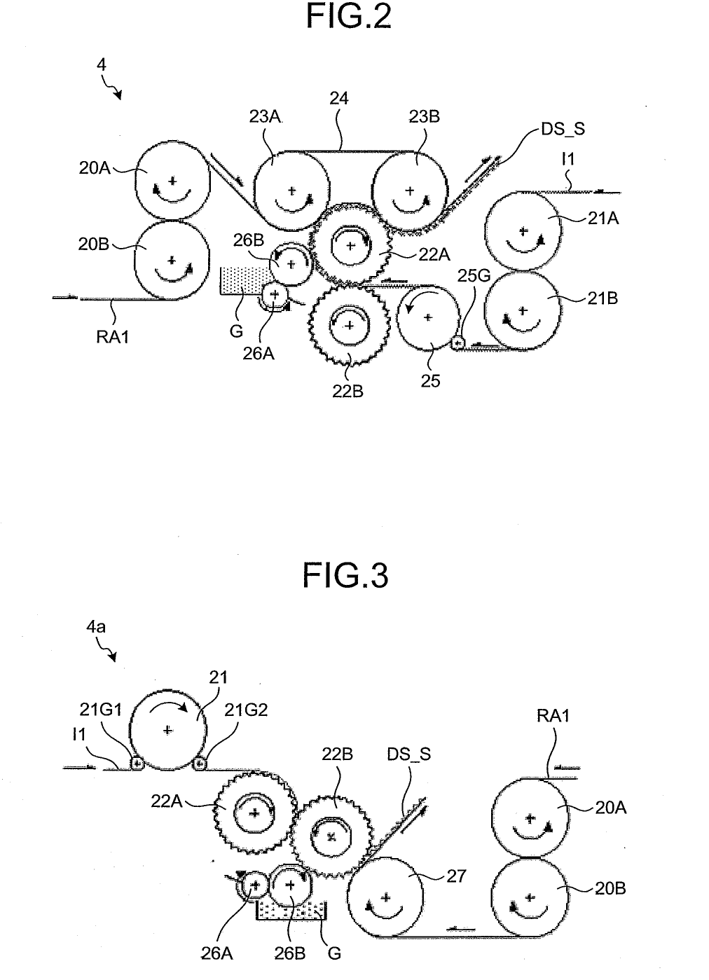

FIGS. 2 and 3 are schematic diagrams of examples of the single facer 4. Specifically, FIG. 2 is a schematic diagram of a belt-pressing type single facer, while FIG. 3 a schematic diagram of a roll-pressing type single facer. The belt-pressing type single facer 4 shown in FIG. 2 is explained first. The single facer 4 is used for gluing the rear liner RA1 and a corrugating medium I1 together, both of which are base sheets of a cardboard sheet. The rear liner RA1 is heated by a first rear liner preheater 20A and a second rear liner preheater 20B, and fed to a pressing belt 24 driven by a belt roll 23A and a stretch roll 23B.

The medium I1 is heated by a first medium preheater 21A and a second medium preheater 21B. After being further heated by a third medium preheater 25, the medium I1 is fed between a first medium forming roll 22A and a second medium forming roll 22B. The medium I1 is wound around the third medium preheater 25 by a guide roll 25G. Heating time of the medium I1 is adjusted by moving the guide roll 25G along the external surface of the third medium preheater 25 in the circumferential direction to adjust the angle for which the medium I1 is wound around the third medium preheater 25.

The first medium forming roll 22A and the second medium forming roll 22B are toothed, and such teeth of each of the first and the second medium forming rolls 22A and 22B of are arranged vertically to a rotating axis of each, and is engaged with each other in a rotating motion. When the medium I1 goes through the area where the teeth are in engagement, the base sheet of the cardboard sheet is formed into a corrugating medium I1. The medium I1 wound around the first medium forming roll 22A contacts a gluing roll 26B, and a glue G from meter roll 26A is supplied on the medium I1 via the gluing roll 26B.

The pressing belt 24 and the first medium forming roll 22A are pressed against each other, and the medium I1 and the rear liner RA1 are held and pressed between the two. In this manner, the medium I1, supplied with glue on one side, is adhered to the rear liner RA1 to form a single-faced cardboard sheet DS_S. Another type of the single facer, a roll pressing type single facer 4a, shown in FIG. 3, is explained below.

In the single facer 4a, a rear liner RA1 is heated by the first rear liner preheater 20A and the second rear liner preheater 20B, and fed onto a pressing roll 27. A medium I1 is heated by a medium preheater 21, and fed between the first medium forming roll 22A and the second medium forming roll 22B. The medium I1 is wound around the medium preheater 21 by guide rolls 21G1 and 21G2. Heating time of the medium I1 is adjusted by moving the guide rolls 21G, 21G2 along the external surface of the medium preheater 21 in the circumferential direction to adjust the angle for which the medium I1 is wound around the medium preheater 21.

When the medium I1, which is fed between the first medium forming roll 22A and the second medium forming roll 22B, goes through the area where the teeth of the first medium forming roll 22A and those of the second medium forming roll 22B are in engagement, the base sheet of the cardboard sheet is formed into a corrugating medium I1. The medium I1 wound around the first medium forming roll 22A contacts the gluing roll 26B, and the glue G from meter roll 26A is supplied on the medium I1 via the gluing roll 26B.

The second medium forming roll 22B and the pressing roll 27 are pressed against each other, and the medium I1 and the rear liner RA1 are held and pressed between the two. In this manner, the medium I1, supplied with glue on one side, is adhered to the rear liner RA1 to form a single-faced cardboard sheet DS_S. The cardboard-sheet manufacturing apparatus 1 includes the belt-pressing type single facer 4 shown in FIG. 2; however, the roll-pressing type single facer 4a as shown in FIG. 3 can also be used.

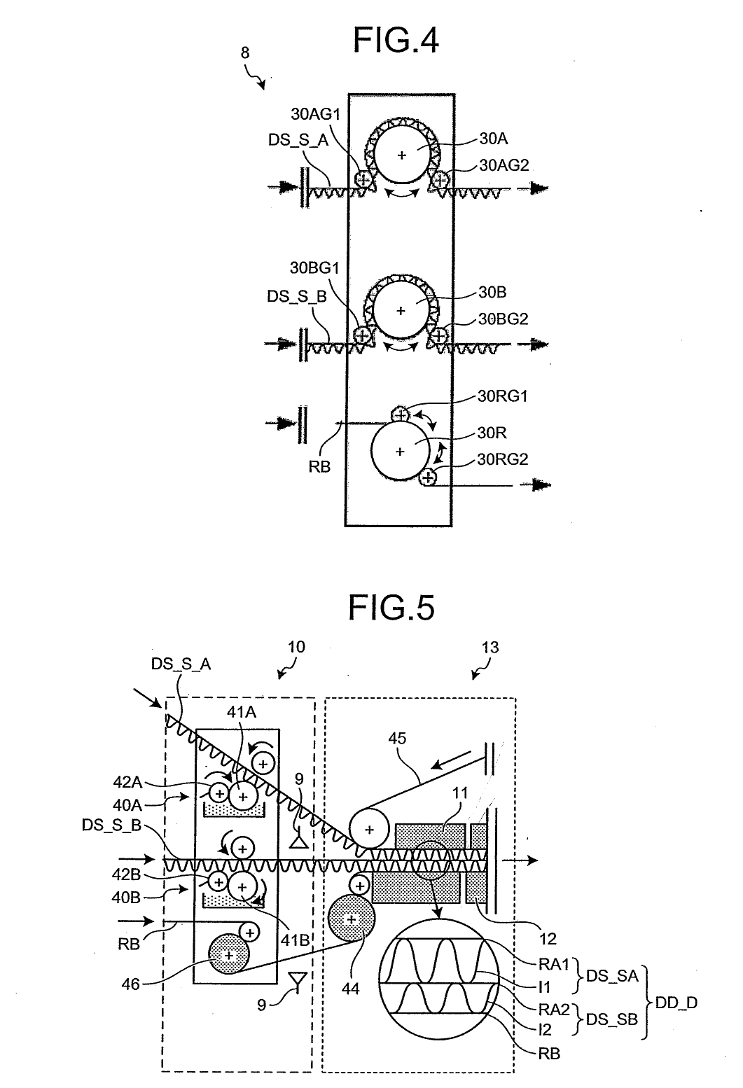

FIG. 4 is a schematic diagram of one example of the preheaters 8. The preheaters 8 are used to heat a single-faced cardboard sheet DS_S_B (or DS_S_A) and a front liner RB, which is a base sheet for a cardboard sheet, before adhering to each other. i.e., at a former stage of the glue machine 10. The preheaters 8 include a first single-faced cardboard sheet preheater 30A, a second single-faced cardboard sheet preheater 30B, and a front liner preheater 30R. Each of the first and the second single-faced cardboard sheet preheaters 30A and 30B can heat a different single-faced cardboard sheet, DS_S_A and DS_S_B.

The first single-faced cardboard sheet DS_S_A is wound around the first single-faced cardboard sheet preheater 30A by guide rolls 30AG1 and 30AG2. Heating time of the first single-faced cardboard sheet DS_S_A is adjusted by moving the guide roll 30AG1 or 30AG2 along the external surface of the first single-faced cardboard sheet preheater 30A in the circumferential direction to adjust the angle for which the first single-faced cardboard sheet DS_S_A is wound around the first single-faced cardboard sheet preheater 30A.

The second single-faced cardboard sheet DS_S_B is wound around the second single-faced cardboard sheet preheater 30B by guide rolls 30BG1 and 30BG2. Heating time of the second single-faced cardboard sheet DS_S_B is adjusted by moving the guide roll 30BG1 or 30BG2 along the external surface of the second single-faced cardboard sheet preheater 30B in the circumferential direction to adjust the angle for which the second single-faced cardboard sheet DS_S_B is wound around the second single-faced cardboard sheet preheater 30B.

The front liner RB is wound around the front liner preheater 30R by guide rolls 30RG1 and 30RG2. Heating time of the front liner RB is adjusted by moving the guide roll 30RG1 or 30RG2 along the external surface of the front liner preheater 30R in the circumferential direction to adjust the angle for which the front liner RB is wound around the front liner preheater 30R.

In order to manufacture a double-faced cardboard sheet, the front liner preheater 30R, and one of the first single-faced cardboard sheet preheater 30A or the second single-faced cardboard sheet preheater 30B is used. In order to manufacture a double-walled cardboard sheet, the front liner preheater 30R, and both of the first single-faced cardboard sheet preheater 30A or the second single-faced cardboard sheet preheater 30B are used. Because the preheaters 8 include three preheaters, multi-faced cardboard sheets can be produced. However, other types of preheaters than that shown in FIG. 4 can also be used in the cardboard-sheet manufacturing apparatus 1.

FIG. 5 is a schematic diagram of the glue machine 10. The glue machine 10 is used for gluing the single-faced cardboards to the front liner, and feeding it to the double facer 13. The glue machine 10 includes a first gluing unit 40A and a second gluing unit 40B. The first gluing unit 40A supplies the glue to the first single-faced cardboard sheet DS_S_A, and the second gluing unit 40B supplies the glue to the second single-faced cardboard sheet DS_S_B.

A first meter roll 42A supplies glue to a first gluing roll 41A. The corrugating medium side of the first single-faced cardboard sheet DS_S_A is in contact with the first gluing roll 41A, and is provided with the glue from the first gluing roll 41A. A second meter roll 42B supplies glue to a second gluing roll 41B. The corrugating medium side of the second single-faced cardboard sheet DS_S_B contacts the second gluing roll 41B, and is provided with the glue from the second gluing roll 41B. The first and the second single-faced cardboards sheets DS_S_A, DS_S_B are fed to the double facer 13, and adhered together. The front liner RB is heated by a first front liner preheater 46 and a second front liner preheater 44, and adhered to the corrugating medium of the second single-faced cardboard sheet DS_S_B by the double facer 13. The heating time of the front liner RB is controlled by adjusting the angle for which the front liner RB is wound around at least one of the first front liner preheater 46 and the second front liner preheater 44.

The moisture content in the second single-faced cardboard sheet DS_S_B and the front liner RB are adjusted by providing water by the shower units 9 before adhering them together. After being fed to the double facer 13, the first single-faced cardboard sheet DS_S_A, the second single-faced cardboard sheet DS_S_B, and the front liner RB are held between the pressing unit 11 and the heating plate 12, and adhered together while being heated. In this manner, the double-walled cardboard sheet DD_D is manufactured. In the double facer 13, a conveyor belt 45 conveys the double-walled cardboard sheet DD_D.

In order to manufacture a double-faced cardboard sheet DD_S, only one of the first gluing unit 40A or the second gluing unit 40B is used in the glue machine 10. In order to manufacture a double-walled cardboard sheet DD_D, both of the first gluing unit 40A and the second gluing unit 40B are used in the glue machine 10. In this manner, the glue machine 10 can manufacture a multi-faced cardboard sheet. However, other types of glue machines than that shown in FIG. 5 can also be used in the cardboard-sheet manufacturing apparatus 1.

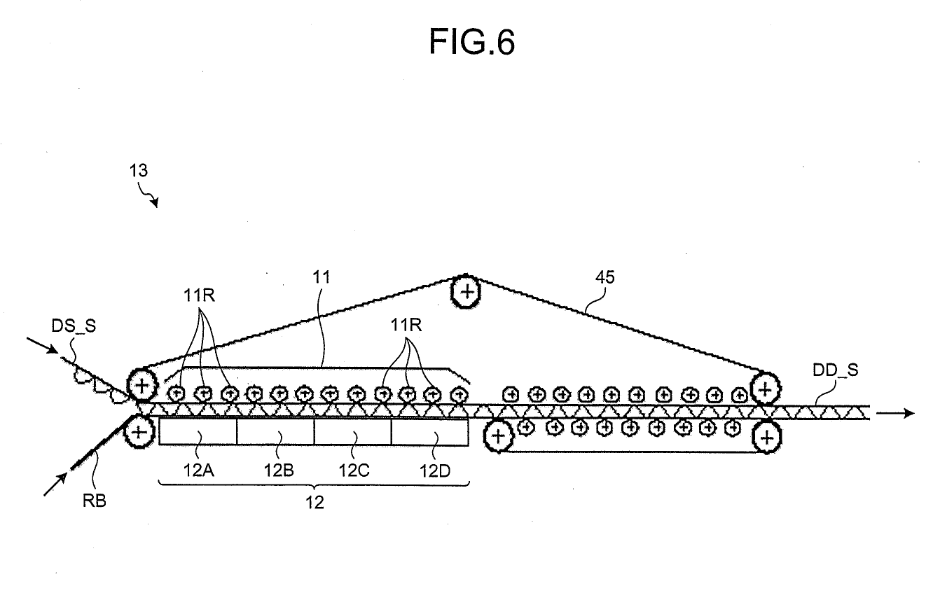

FIG. 6 is a schematic diagram of the double facer 13. As shown in FIG. 6, a single-faced cardboard sheet DS_S and the front liner RB are adhered together to form a double-faced cardboard sheet DD_S. However, the double facer 13 may also be used for forming a multi-faced cardboard sheet by adhering two single-faced cardboard sheets and the front liner RB. The double facer 13 includes the conveyor belt 45, the pressing unit 11, and the heating plate 12. The conveyor belt 45 conveys the single-faced cardboard sheet DS_S and the front liner RB. The pressing unit 11 press the single-faced cardboard sheet DS_S and the front liner RB, which is conveyed by the conveyor belt 45, against the heating plate 12, to adhere them together. The heating plate 12 heats the single-faced cardboard sheet DS_S and the front liner RB to promote the glue to dry.

By changing the pressure added by the pressing unit 11, the contact thermal conductance between the heating plate 12 and the front liner RB also changes. As a result, the amount of heat transferred from the heating plate 12 to the single-faced cardboard sheet DS_S and the front liner RB also changes. Therefore, by changing the pressure added by the pressing unit 11, the amount of heat transferred from the heating plate 12 to the single-faced cardboard sheet DS_S and the front liner RB can be controlled.

The pressing unit 11 includes a plurality of pressing rolls 11R. The heating plate 12 is divided into a plurality of heating groups (four, in this embodiment) 12A to 12D that are internally supplied with vapor, to heat the single-faced cardboard sheet DS_S and the front liner RB. By dividing the heating plate 12 into the groups, temperature is distributed along the feeding direction of the single-faced cardboard sheet DS_S and the front liner RB. In this manner, the amount of heat added to the single-faced cardboard sheet DS_S and the front liner RB can be easily controlled. The controlling system 100 for the cardboard-sheet manufacturing apparatus 1 is described below referring to FIGS. 1 to 6 as appropriate.

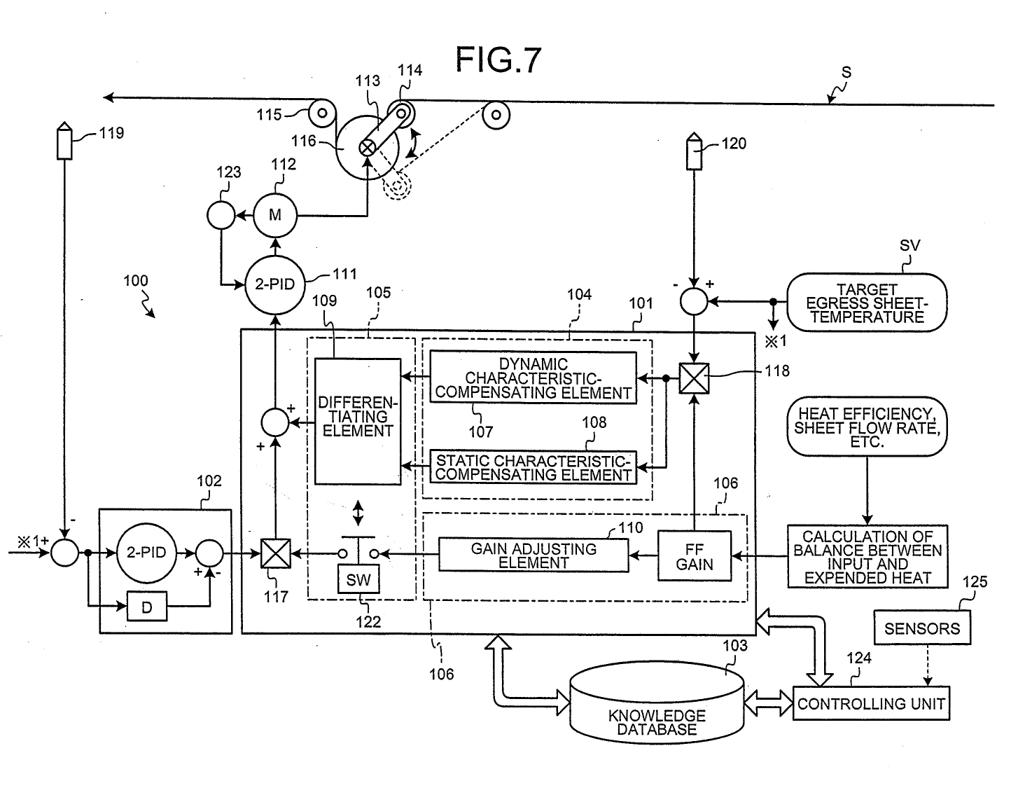

FIG. 7 is a schematic diagram for explaining how sheet temperature is controlled by the controlling system 100 for the cardboard-sheet manufacturing apparatus 1. In this example, the controlling system 100 controls the temperature of the sheets through each of the preheaters 8; however, the same process can be applied to the units that require sheet-temperature control (e.g., the rear liner preheater 3, or the pressing unit 11 or the heating plate 12 in the double facer 13).

A front liner preheater 116 is a heater having a tube-like form, and heats a sheet S (front liner or single-faced cardboard sheet) wound around the surface thereof by a first guide roll 114 and a second guide roll 115. The position of the first guide roll 114 can be moved with an arm 113 in the circumferential direction of the front liner preheater 116. The heated time of the sheet S is adjusted by changing the angle for which the sheet S is wound around the front liner preheater 116, by rotating the arm 113 around the axis of the front liner preheater 116 to change the position of the first guide roll 114 with respect to the circumferential direction of the front liner preheater 116.

The arm 113 is driven by an arm-driving motor 112 that changes the angle for which the sheet S is wound around the front liner preheater 116 (hereinafter, sometimes referred to as “wound angle”). A PID controller 111 is connected to the arm-driving motor 112, and is controlled by FB control based on signals transmitted from an encoder 123 that is attached to the driving axis of the arm-driving motor 112. In the FB control for the arm-driving motor 112, a two-degree-of-freedom PID algorithm, which is described later on this specification, is used. However, the PID algorithm used for the FB control of the arm-driving motor 112 is not limited to that of two-degree-of-freedom.

The controlling system 100 for the cardboard-sheet manufacturing apparatus 1 includes an FF/FB controlling unit 101, a PID controller 102, and the knowledge database 103. The controlling system 100 further includes a controlling unit 124 that controls the cardboard-sheet manufacturing apparatus 1. The controlling unit 124 is connected to sensors 125 that obtain information required for controlling the cardboard-sheet manufacturing apparatus 1. The controlling unit 124 is also connected to the knowledge database 103. The knowledge database 103 constantly updated with information related to the conditions of the cardboard-sheet manufacturing apparatus 1, which are obtained from the sensors 125, and control data for the controlling unit 124 to control the cardboard-sheet manufacturing apparatus 1. The controlling unit 124 controls the cardboard-sheet manufacturing apparatus 1 based on the information stored in the knowledge database 103.

The knowledge database 103 accumulates the associated information of the evaluation information of a manufactured cardboard sheet, the temperature or the moisture content information of the sheet (base sheet or single-faced cardboard sheet), and manufacturing-related information at the time the cardboard was manufactured. In other words, the knowledge database 103 stores and accumulates therein past records of manufacturing process and distribution process of a cardboard sheet. Such a database is useful upon preparing a future manufacturing plan, because past records of the manufacturing or the distribution process, or past records for the specific customer would allow easy identification of risks, and more accurate planning. By taking advantage of the knowledge database 103 effectively, manufacturing, sales, or inventory can be managed more smoothly. Because the knowledge database is also input with information obtained from experience and intuition of operators, such information is also reflected in control of the cardboard-sheet manufacturing apparatus 1.

In the cardboard-sheet manufacturing apparatus 1, temperature (moisture content) of a cardboard sheet or a base sheet is controlled by the controlling system 100. The controlling system 100 is incorporated with a so-called advanced FF/FB control. The FF/FB controlling unit 101 performs the advanced FF/FB control to control temperature (moisture content) of the cardboard sheet or the base sheet to an appropriate value. As a result, defective adhesion of cardboard base sheets can be reduced, warpage or defective adhesion of the manufactured cardboard sheet can be controlled accurately, and high quality cardboard sheets can be manufactured.

The PID controller 102, which is used for the FB control, utilizes temperature of a sheet S after heated by the front liner preheater 116 (hereinafter, “egress sheet-temperature”) as a FB signal. The egress sheet-temperature is measured by an egress temperature sensor 119. A target egress sheet-temperature is input to the PID controller 102 as a FB control target value, i.e., a set variable (SV). The output from the PID controller 102 is input to a first multiplier 117 in the FF/FB controlling unit 101. The FF/FB controlling unit 101 controls the arm-driving motor 112 to adjust the egress sheet-temperature to the target egress sheet-temperature.

The sheet temperature before heated by the front liner preheater 116 (hereinafter, “ingress sheet-temperature”) is input to the PID controller 102 as a disturbance. The ingress sheet-temperature is measured by an ingress temperature sensor 120. The ingress sheet-temperature is input to the first multiplier 117 in the FF/FB controlling unit 101 along with the egress sheet-temperature. A second multiplier 118 receives FF gain. The output from the second multiplier 118 is input to a dynamic characteristic-compensating element 107 and a static characteristic-compensating element 108 in a separate FF/FB controlling unit 104 in the FF/FB controlling unit 101.

A gain-scheduling FF/FB controlling unit 106 receives calculation result of input and expended heat (water) balance in the sheet S. The balance between input and expended heat (water) is calculated by a function having parameters of (measured) flow rate of the sheet S and heat efficiency.

The flow rate of the sheet S is calculated from sheet width, basis weight, and speed, and the heat efficiency is calculated from specific heat, thermal conductivity, and so on. In this manner, the heat (water) balance of the sheet S is calculated to represent a value during the manufacturing process of the sheet S.

In the controlling system 100, the two-degree-of-freedom PID algorithm is incorporated in the PID controller 102 for the FB control. The two-degree-of-freedom PID control enables optimization of a following capability to change in the target value, while maintaining a disturbance-suppressing characteristic at an optimal level. In this manner, advantages such as improved controllability of the temperature (or the moisture content of the sheet S), easy adjustment, and better control stability can be achieved. The two-degree-of-freedom PID control is realized by adding a target-value filter to a target value of process variable (PV)-derivative type PID control (PI-D control), which is a one-degree-of-freedom PID control. According to the first embodiment of the present invention, the PID controller 111 has a derivative term D as a target-value filter, and the two-degree-of-freedom PID control is realized by inverse compensation by the derivative term D.

According to the first embodiment, while the PID parameter values in the PID controller 111 are held to keep the disturbance-suppressing characteristic at an optimal level, the parameters of the target-value filter is adjusted to optimize the target-value-following characteristic. At the same time, the PID parameters and the parameters of target-value filter can be adjusted independently. The two-degree-of-freedom PID control has different levels: a partial control that allows freedom only in P operation, PD operations, or all of PID operations, or a complete control.

The FF/FB controlling unit 101 can select one of three types of FF/FB controls depending on the conditions: the separate FF/FB control, the gain-scheduling FF/FB control, and a selective-combining FF/FB control. The selective-combining FF/FB control controls both the separate FF/FB control and the gain-scheduling FF/FB control, and switches the FF and FB control suitably to optimize controlling performance. In the first embodiment, the FF control and the FB control are switched based on control parameters in the knowledge database 103, that correspond to the operating conditions of the cardboard-sheet manufacturing apparatus 1 or the cardboard sheet manufacturing conditions.

The “separate FF/FB control” is the FB control combined with the FF control that couples compensation for static characteristic and that for dynamic characteristic by addition in an FF control model, with the compensation for the static characteristic being a speed-form signal, and that for the dynamic characteristic being a position-form signal. A first-order approximation of a transfer function of process and disturbance can be expressed by Equation as follows:

F(s)=K×[1+δ×{(1+Tp)/(1+Td)−1}]

Where, K=Kd/Kp, Kd is a disturbance gain, Kp is a process gain, Tp is a process time constant, and Td is a disturbance time constant. K represents the static characteristic compensation, and δ{(1+Tp)/(1+Td)−1} represents the dynamic characteristic compensation.

Because the dynamic characteristic compensation is 0 at steady condition, even if the nonlinear factor δ is modified arbitrarily, the static quantativity is not affected. The separate FF/FB control can be given with “blind zone”, “upper or lower boundary value”, or “directionality”, depending on controlling needs or the limiting conditions of the process. Therefore, the boundaries can be adjusted to maximize the effect of the FF control. As a result, the controlling system 100 is less affected by the flow rate or the temperature of the cardboard sheet, and to enable easy adjustment of the parameters and boundaries. The separate FF/FB control function is provided in the separate FF/FB controlling unit 104 in the FF/FB controlling unit 101.

The gain-scheduling FF/FB control is the separate FF/FB control that is added with a controlling function that changes FB control gain in proportion to the amount of the disturbance, and is suitable for a process where the process gain changes depending on the amount of a load. The gain-scheduling FF/FB control has advantages that the controlling system using thereof is less affected by the flow rate or the temperature changes the cardboard sheet base sheet. In addition, a scheduling function and an operation characteristic correcting function for the heating time and the speed of the cardboard sheet enable the controllability to be less degraded, or hunting to be reduced. In this manner, a controlling system that is robust against the load can be realized. The gain-scheduling FF/FB control is realized by a gain adjusting element 110 in the gain-scheduling FF/FB controlling unit 106 of the FF/FB controlling unit 101. The gain adjusting element 110 has a gain scheduling function.

The selective-combining control basically uses the separate FF/FB control, and does not always combine FF control and FB control. The selective-combining control ceases to use FB control, or uses only P control, when the dynamic characteristic compensation component exceeds a predetermined value. In this manner, in the selective-combining FF/FB control mainly uses FF control in a transitional period, and FF control+FB control at steady time, with the FB control compensating the FF control.

The selective-combining FF/FB control locks the FB control (holds the FB output) during a period the dynamic characteristic compensation exceeds a predetermined value, that is, during the period the dynamic compensation is in operation, and suitably switches the FF control and the FB control, to enable the control performance to be optimized. The selective-combining FF/FB control is effective for non-random processes, such as process where disturbance characteristics changes the manufactured volume in a systematical manner, or the amount of a load changes from one predetermined value to another, and a large wasted time or time constant.

The selective-combining FF/FB control is realized by a selective-combining FF/FB controlling unit 105 in the FF/FB controlling unit 101. The selective-combining FF/FB controlling unit 105 includes a differentiating element 109 and an FF/FB switching unit 122. The differentiating element 109 switches between FF control and FB control based on the information in the knowledge database 103.

In the controlling system 100, historical records of the optimal operations of the past are stored in a chronological order in the knowledge database 103 for each customer, product, or operation pattern. Before starting to manufacture the cardboard sheets, the most appropriate operating information is selected from the knowledge database 103 as basic information for the operation. Once the manufacturing begins, the controlling unit 124 determines the conditions of and learns the operating information collected by the fieldbus, and feedbacks the leaned results to the knowledge database 103 for storage. As the controlling unit 124 predicts the conditions of each controlling unit by observing the current conditions thereof based on a controlling model created from the stored results in the knowledge database 103, the FB control and FF control are switched, at the same time the parameters thereof are finely adjusted overtime, updating the best operation conditions of the past. If an operator intervenes, experienced manipulation of the operator supersedes the learning process, and the operation record is re-calculated, and the knowledge database 103 is updated.

The controlling system 100 differentiates between the static compensation and dynamic compensation for the FF/FB control, and switches FF control and FB control based on the differentiated result. In this manner, the quality of the cardboard sheets can be controlled more accurately, with less influence by the disturbance and better target-following capability. In the cardboard manufacturing process, because the process handles papers, it is difficult to predict the quality of the cardboard sheet produced under specific operating conditions of the cardboard-sheet manufacturing apparatus 1. Furthermore, even if a same type of papers is used, the temperature or the moisture content changes depending on production. Therefore, it has been difficult to improve the target-following capability with the matrix control or a simple FF/FB control. In addition, because the conventional matrix control depends on intuitions and experiences of operators, the qualities of the cardboard sheet could become inconsistent when the operator is changed.

In the controlling system 100, the knowledge database 103 is created with association to the intuitions and experiences of the operators, such intuitions and experiences of operators are reflected to the controlling process of the cardboard-sheet manufacturing apparatus 1. As a result, the qualities of the cardboard sheets can be controlled more accurately, and produce high quality cardboard sheets with less warpage or defective adhesion.

Also, applying the knowledge database 103 has an advantage explained below. In a conventional matrix control, a global model is created from an archive of controlling data of the past; however, when there is some non-linearity in the data, some part of the data could possibly end up being out the model. To the contrary, if control models are created from a knowledge database, a large numbers of partial linear models are created. Therefore, even when there is some non-linearity, a highly accurate prediction becomes possible with simple liner models. Moreover, the know-how and knowledge of operators are all stored in the knowledge database, chances of missing or losing data can be minimized and safety is improved. In addition, even when the controlled value did not measure to the target value, such data can be provided to the knowledge database and learned again for future control.

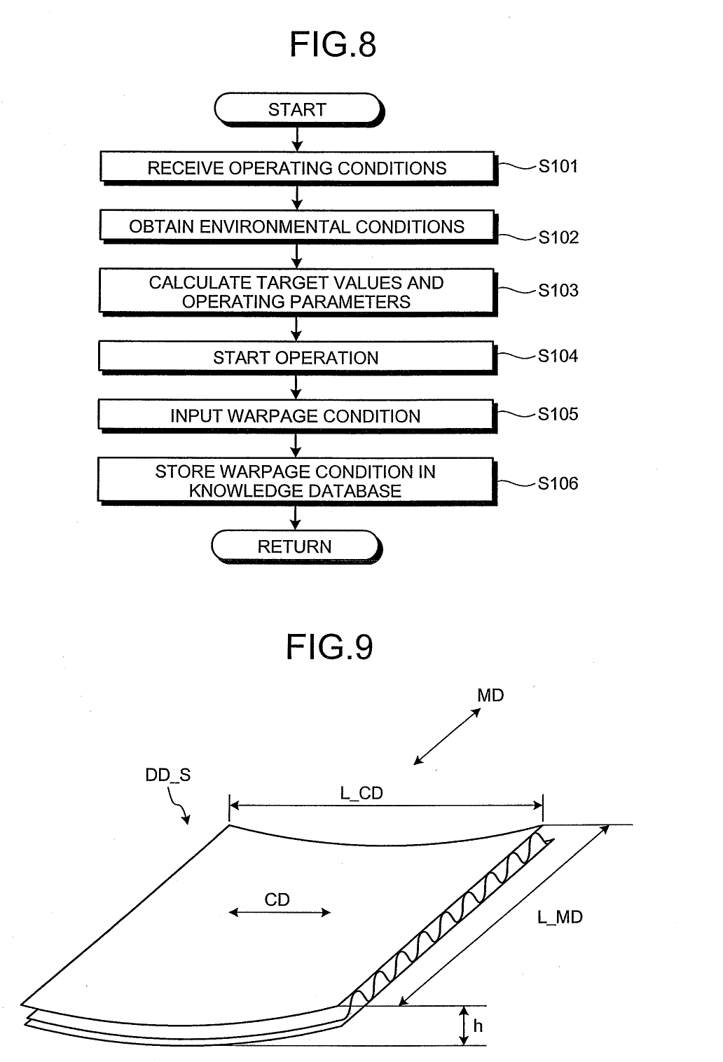

FIG. 8 is a flowchart of a cardboard-sheet manufacturing process performed by the controlling system 100. The controlling unit 124 receives operating conditions (step S101). The operating conditions include a type of single-faced cardboard sheet manufactured, paper type, basis weight, sheet width, size, finished quantity, planned length, and target operation speed, and they are determined based on a manufacturing plan. Then, the controlling unit 124 obtains environmental conditions (step S102), and stores the obtained conditions to the knowledge database 103. The controlling unit 124 calculates operating parameters and target values for the egress sheet-temperature, the moisture content, or the amount of glue provided, based on the operating conditions and the environmental conditions (step S103). For the operating parameters and target values of the egress sheet-temperature, the moisture content, or the amount of glue provided, the ones corresponding to the operating conditions and the environmental conditions respectively obtained at the steps S101 and S102 are selected from the past information accumulated in the knowledge database 103.

After the operating parameters and the target values of the egress sheet-temperature, and on the like are calculated, the cardboard-sheet manufacturing apparatus 1 begins operation (step S104) using such target values and operating conditions, and start manufacturing a cardboard sheet. The controlling system 100 controls controlled values (e.g., temperature, moisture content, or tension of a base sheet or a cardboard sheet, heating time, volume of water added, and operation speed) using the target values and the operating parameters obtained at step S103.

The warpage of a manufactured cardboard sheet is evaluated, and the evaluation information is input to the knowledge database 103 and stored therein (steps S105 and S106). FIG. 9 is a schematic diagram for explaining a method for evaluating warpage of a finished double-faced cardboard sheet. As shown in FIG. 9, when a finished double-faced cardboard sheet DD_S is warped, the double-faced cardboard sheet DD_S becomes arc in shape. The direction that the sheet S is conveyed in the cardboard-sheet manufacturing apparatus 1 is indicated as MD, and the direction perpendicular to the MD direction is indicated as CD.

In the warped, double-faced cardboard sheet DD_S, the vertical displacement (in the direction perpendicular to the surface of the cardboard sheet) is shown as h, the length of the double-faced cardboard sheet DD_S in the MD direction is shown as L_MD, and the length of the double-faced cardboard sheet DD_S in the CD direction is shown as L_CD. The warpage of a double-faced cardboard sheet DD_S is evaluated by the warpage factor (WF). WP is defined to be 0.25 with a cardboard sheet of size L_MD=L_CD=1 meter having the displacement h of 17 millimeters. If WP≦0.25, then, it can be considered no defects are caused due to the warpage of the double-faced cardboard sheet DD_S (e.g., feeding error upon reversing the sheet in the cardboard-sheet manufacturing apparatus 1, or faulty feeding of the double-faced cardboard sheet DD_S within the cardboard-sheet manufacturing apparatus 1).

When an operator evaluates the warpage of the double-faced cardboard sheet DD_S, the evaluation information is manually input to the knowledge database 103. In the cardboard-sheet manufacturing apparatus 1, the conditions of the cardboards DD_S that are stacked in the double-faced cardboard sheet storage unit 16 are photographed by the camera 17, an imaging unit, and the photographed images are analyzed in the image processing/evaluating unit 18 to evaluate the warpage of the double-faced cardboard sheets DD_S. The evaluation results are input to the knowledge database 103. In this manner, the warpage evaluation of the double-faced cardboard sheet DD_S and update of the knowledge database 103 can be automated.

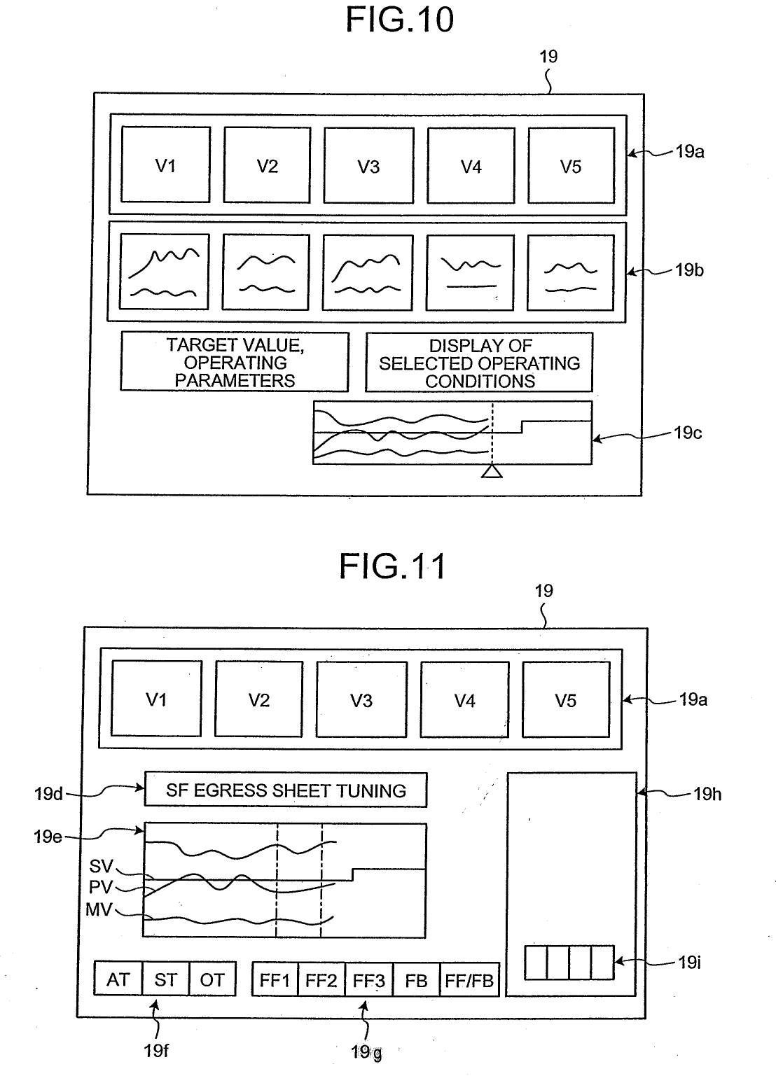

FIG. 10 is a schematic diagram of one example of display screen of the controlling system 100 during the cardboard-sheet manufacturing apparatus 1 is in operation. As shown in FIG. 10, the cameras (imaging units) are provided at each unit of the cardboard-sheet manufacturing apparatus 1 to monitor the conditions of the base sheet and the cardboard sheets while the cardboard-sheet manufacturing apparatus 1 is in operation (only one camera, monitoring the stacked sheet, is shown in FIG. 1). The conditions of the base sheets or the cardboard sheets, which are photographed by each camera during operation of the cardboard-sheet manufacturing apparatus 1, are displayed on an image display area 19a on the image displaying unit 19. In this example, images photographed by cameras at five locations are being displayed (images V1 to V5).

A control status display area 19b can display the control status of the temperature and so on at each unit photographed by each camera. A zoom display area 19c can display the control status of the temperature and so on of the base sheet or the cardboard sheet at a selected unit in an enlarged view. In this manner, because the conditions or the control status of the base sheet or the cardboard sheets can be monitored in real-time, prompt action can be taken if any defect is found. In this manner, defective fraction can be reduced.

If any warpage exceeding a tolerable amount is found in a manufactured cardboard sheet, or if the temperature of a manufactured cardboard sheet largely deviates from a target value, the operating parameters of the cardboard-sheet manufacturing apparatus 1 are adjusted. FIG. 11 is a schematic diagram of one example of an adjustment screen of the controlling system 100. As shown in FIG. 11, because the conditions of the base sheets or the cardboard sheets, which are photographed by each camera, are displayed on the image display area 19a, an operator can adjust the operating parameters while monitoring the actual conditions of the base sheet or the cardboard sheet.

Upon adjusting the operating parameters, the operator can select the unit to change the operation parameter. In the example of FIG. 11, the operator has selected the egress area of the single facer (SF) 4. An adjustment display area 19d displays necessary adjustment, and a zoom display area 19e displays the control status at the adjusted unit. In this example, the zoom display area 19e displays a set variable (SV), a process variable (PV), and a manipulated variable (MV).

An adjustment-mode display area 19f displays a current adjustment mode. In this example, it displays an adjustment mode for tuning the control parameters of the two-degree-of-freedom PID control. In the FIG. 11, AT stands for Auto Tuning, ST stands for Self Tuning, and OT stands for Operator Tuning. In the adjusted-parameter display area 19g, the parameter currently being adjusted is displayed. In this example, the operation parameters of the FF/FB controlling unit 101 are being adjusted. FF1 as used herein indicates gain adjustment, FF2 is deviation adjustment, FF3 is disturbance adjustment, FB is adjustment of the two-degree-of-freedom PID control, FF/FB is overall FF/FB control adjustment.

An adjustment-information display area 19h displays a note made by an operator upon adjustment of the operating parameters. This note records observations made by the operator upon adjustment of the operating parameters, and is stored in the knowledge database 103. For example, the operator can input information such as date and time of the adjustment, operating conditions, environmental conditions, adjusted conditions, and adjustment mode to this note. The conditions of the base sheet or the cardboard sheet upon adjustment can also be stored as an image. Such an image of the base sheet or the cardboard sheet conditions is photographed by the camera, and displayed in the stored image displaying are 19i within the adjustment-information display area 19h. With this display area, the operator can check the image to be stored.

The controlling system 100 controls each controlled object by switching the FF/FB controls using the knowledge database 103. Because the knowledge database 103 creates a large numbers of partial linear models, a highly accurate prediction becomes possible with simple liner models, even when some non-linearity do exist. Furthermore, because the knowledge database 103 stores therein all of the know-how and knowledge of operators, chances of missing or losing data can be minimized and safety is improved.

In addition, even when the controlled value did not measure to the target value, such data can be stored in the knowledge database and learned again for future control. As a result, the controlling system 100 can reduce defective adhesion of cardboard base sheets, further reducing the warpage or defective adhesion of the manufactured cardboard sheets; therefore high quality cardboard sheets are manufactured. Furthermore, incorporating the knowledge database has advantages that labor expenses can be cut down and trainings for operators can be reduced, by allowing easy automation of the control and reducing adjustment workload on operators. The structure according to the first embodiment can be applied to the following embodiments.

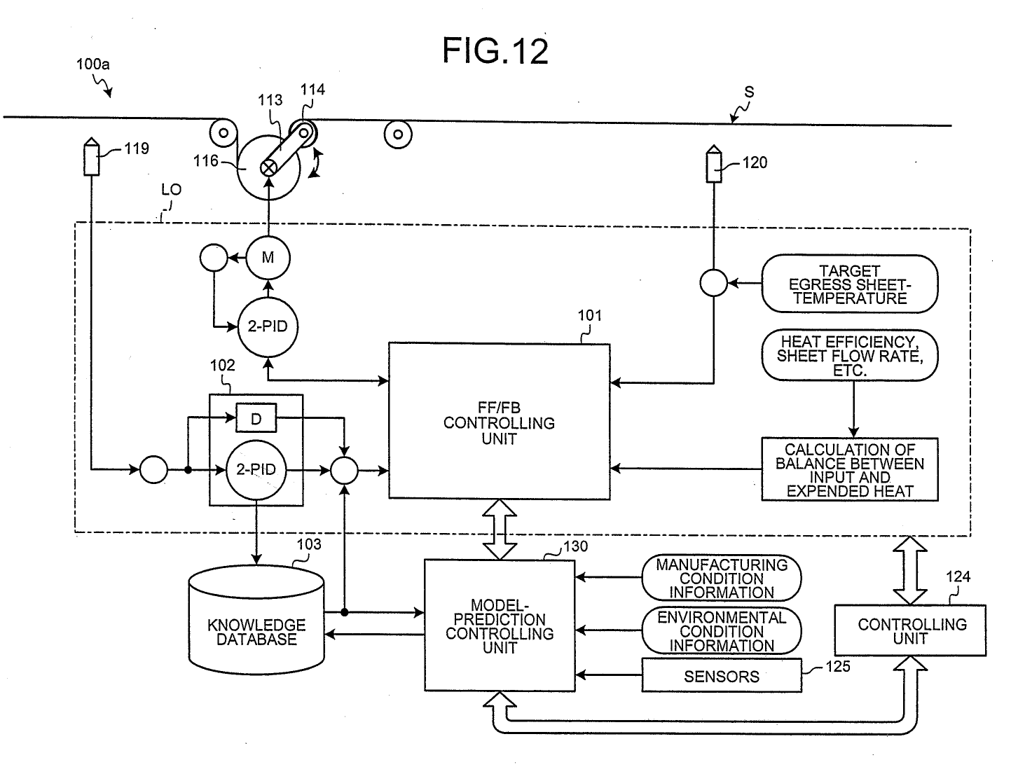

FIG. 12 is a schematic diagram for explaining sheet-temperature control performed by a controlling system 100a for the cardboard-sheet manufacturing apparatus according to a second embodiment of the present invention. The controlling system 100a is of basically the same structure as the controlling system 100, except for a high-level controlling unit and a low-level controlling unit. The high-level controlling unit refers to the information about the manufacturing conditions, the environmental conditions, and conditions of the cardboard-sheet manufacturing apparatus, and predicts a control model (mathematical model, e.g., the FF model) using a knowledge database. The lower-level controlling unit refers to the control parameters of the two-degree-of-freedom PID control, that are adjusted based on the egress sheet-temperature (moisture content) of the sheet after heated by a heater, corrects the gain for FF/FB control based on the information in the knowledge database, and inputs the corrected gain to the FF/FB controlling unit as an FB signal.

The controlling system 100a include a high-level controlling unit GO and a lower-level controlling unit LO, both of which are connected via a communication circuit to allow information exchange. The low-level controlling unit LO further includes the FF/FB controlling unit 101 and the PID controller 102. The high-level controlling unit GO further includes a model-prediction controlling unit 130 and the knowledge database 103, both of which are connected via a communication circuit to allow information exchange.

According to the second embodiment, the low-level controlling unit LO refers to the controlling parameters of the PID two-degree-of-freedom control, where such controlling parameters are adjusted based on the egress sheet-temperature (moisture content), and corrects the FF/FB control gain based on the knowledge database 103, and input the corrected gain to the FF/FB controlling unit as an FB signal. In this manner, the low-level controlling unit LO controls the egress sheet-temperature with FF/FB control during the operation of the cardboard-sheet manufacturing apparatus 1 (see FIG. 1).

The high-level controlling unit GO refers to the information about the manufacturing conditions of the cardboard sheet, environmental information detected by sensors 125, information about the conditions of the cardboard-sheet manufacturing apparatus 1 (see FIG. 1) obtained from sensors 125 or control command values, and the model-prediction controlling unit 130 predicts the control model based on the information stored in the knowledge database 103. The control models are mathematical prediction models having optimal sheet temperature and moisture content for the cardboard-sheet manufacturing apparatus 1. The control models are prepared in advance by analyzing the data accumulated in the knowledge database 103.

This structure allows the high-level controlling unit GO to monitor and manipulate the large volume of input-output data that are handled by the model-prediction controlling unit 130, which controls the model prediction. Because the high-level controlling unit GO can manage the input-output data handled by the model-prediction controlling unit 130 in an integrated and centralized manner, the controlling system can be simplified, at the same time, speed and accuracy can be improved.

In a conventional matrix control, a global model is created from an archive of controlling data of the past; however, when there is some non-linearity in the data, some part of the data could possibly end up being out the model. To the contrary, if control models are created from the knowledge database 103, such as in the controlling system 100a, a large numbers of partial linear models are created. Therefore, even when there is some non-linearity, a highly accurate prediction becomes possible with simple liner models. In addition, the layered structure of the high-level controlling unit GO and the low-level controlling unit LO enables centralized monitoring and manipulation of the interrelated processes. In this manner, optimal operation environment can be achieved, and cumbersome operations can be removed.

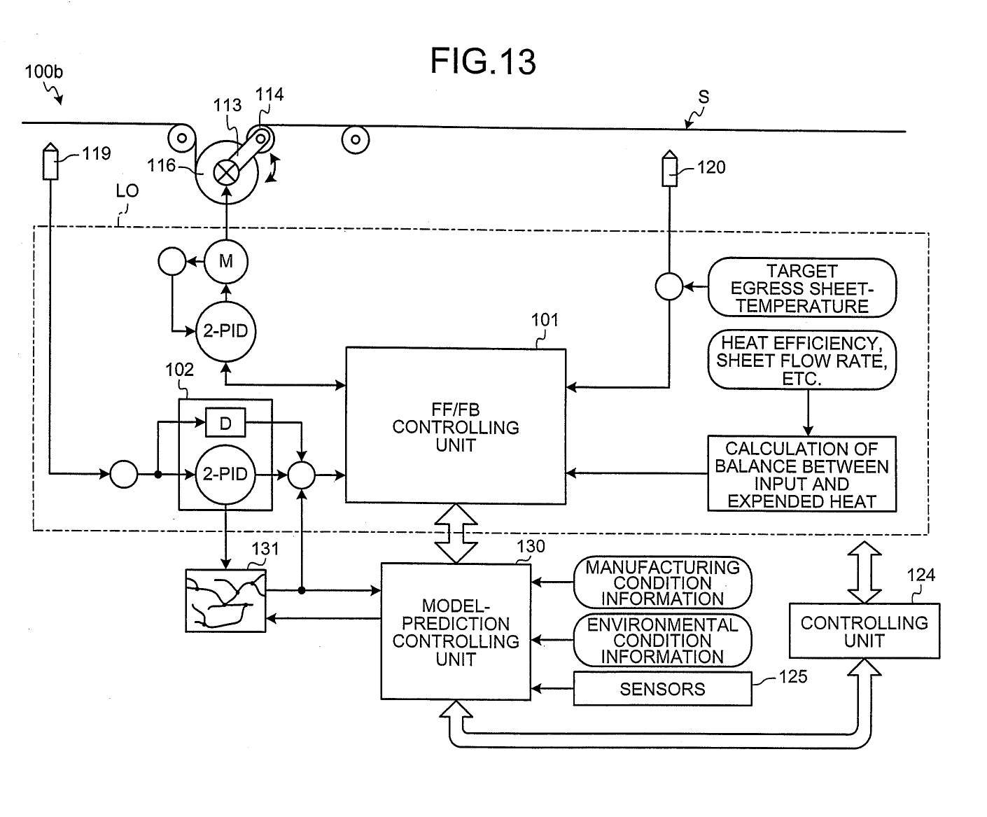

FIG. 13 is a schematic diagram for explaining a controlling system 100b for a cardboard-sheet manufacturing apparatus according to a modification of the second embodiment. The controlling system 100b is of basically the same structure as the controlling system 100a (see FIG. 12), except for a neural network 131 and a fieldbus are used instead of the knowledge database 103 (FIG. 12). Therefore, the same explanations are not repeated. In this modification, the neural network 131 is layered in structure. Before starting to manufacture the cardboard sheets, the most appropriate operating information for the product to be manufactured is selected as basic information. Each neural network determines and learns the conditions from the operating information collected by the fieldbus, and feedbacks the leaned results to the model-prediction controlling unit 130. As future conditions of the controlling units are predicted from the current conditions thereof based on the controlling model created by the model-prediction controlling unit 130, the FB and FF controls are switched back and forth, at the same time, the parameters are finely adjusted over time, updating the best operating records. If an operator intervenes, experienced manipulation of the operator supersedes the learning process, and the operation record is re-calculated. In this manner, because the controlling system 100b uses the neural network 131, it is not necessary to create and maintain a large volume of database, such as the knowledge database 103.

The controlling systems 100a and 100b need not have the knowledge database 103 or the neural network 131. In such a controlling system without the knowledge database 103 or the neural network 131, because the high-level controlling unit GO can monitor and manipulates the large volume of input-output data that are handled by the model-prediction controlling unit 130, which controls the model prediction, the high-level controlling unit GO can manage the large volume of input-output data that are handled by the model-prediction controlling unit 130 in an integrated and centralized manner. As a result, the controlling system can be simplified, at the same time, speed and accuracy can be improved. The structure according to the second embodiment and the modification thereof can also be applied to following embodiment.

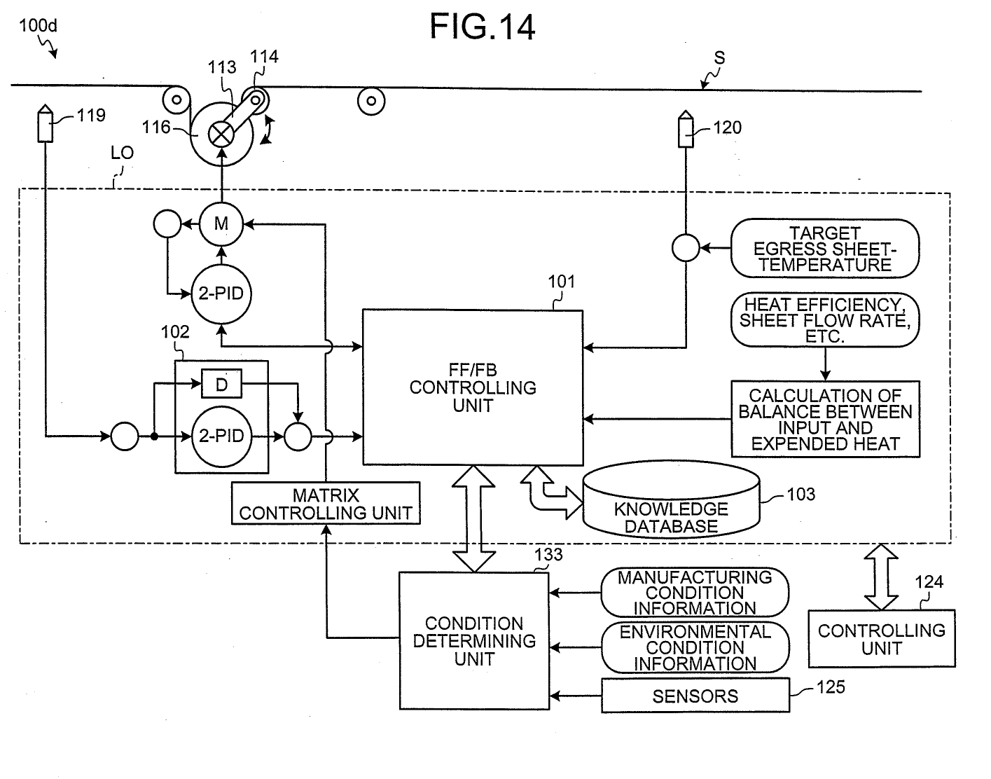

FIG. 14 is a schematic diagram for explaining a controlling system 100d for a cardboard-sheet manufacturing apparatus according to a third embodiment of the present invention. The controlling system 100d is of basically the same structure as the controlling system 100a, except for a high-level controlling unit and a low-level controlling unit, and the same explanations are not repeated. The high-level controlling unit obtains the information about the manufacturing conditions, the environmental conditions, and conditions of the cardboard-sheet manufacturing apparatus, and switches the control between a matrix control and the FF/FB control explained in the first embodiment. The term “matrix control” as used herein refers to a controlling method such that control parameters of a cardboard sheet changes according to a matrix table of operating patterns such as the angle at which the sheet is wound around a heating roll that is set based on the operation speed, the sheet width, and the paper type.

The controlling system 100d has a layered structure of the high-level controlling unit GO and the low-level controlling unit LO including a condition determining unit 133, thereby being capable of centralized monitoring and manipulation of the interrelated processes. In this manner, optimal operation environment can be achieved, and cumbersome operations can be removed. Also, because the control can be switched between a matrix control and the FF/FB control explained, the operation can be optimized according to the manufacturing conditions of the cardboard sheet, the environmental conditions, and the conditions of the cardboard-sheet manufacturing apparatus 1 (FIG. 1).

As set forth hereinabove, according to an embodiment of the present invention, a controlling system can be less affected by sheet temperature or sheet flow rate, and be more robust against load fluctuation. Besides, appropriate control can be selected depending on manufacturing conditions or environmental conditions, etc. Therefore, the quality of cardboard sheets can be controlled with high accuracy.

Moreover, workload for creating and maintaining a large volume of database can be eliminated. With this, a storage unit can be reduced in size.

Furthermore, the cycle of manufacturing, accumulating evaluation information, and manufacturing again can be automated. In addition, like control as the skills of an experienced operator can be realized. Thus, an inspection step is not required, which achieves lower running cost.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A controlling system for a cardboard-sheet manufacturing apparatus comprising:
a first control unit that performs at least one of feedforward control and feedback control for manufacturing of a cardboard sheet to control at least one of temperature and moisture content of the cardboard sheet in process to a target value;
an information providing unit that stores therein information on evaluation of the cardboard sheet manufactured, information on any one of the temperature and the moisture content of the cardboard sheet in process, and information related to the manufacturing of the cardboard sheet in an associated manner; and
a second control unit that changes control parameters of the feedforward control and the feedback control based on the information stored in the information providing unit.

2. The controlling system according to claim 1, wherein the first control unit performs, as the feedforward control and the feedback control, separate feedforward and feedback control, gain-scheduling feedforward and feedback control, and selective-combining feedforward and feedback control.

3. The controlling system according to claim 1, wherein the first control unit performs the feedback control using a two-degree-of-freedom proportional-integral-derivative algorithm.

4. The controlling system according to claim 1, wherein the first control unit adjusts feedback gain based on the information stored in the information providing unit, and used adjusted feedback gain as a feedback signal for the feedback control.

5. The controlling system according to claim 1, wherein the information providing unit is a knowledge database.

6. The controlling system according to claim 1, wherein the information providing unit is any one of a fieldbus and a neural network.

7. The controlling system according to claim 1, further comprising a switching unit that switches operation of the cardboard-sheet manufacturing apparatus between control by the first control unit, and control using a control matrix that describes patterns of operation of the cardboard-sheet manufacturing apparatus, each pattern corresponding to operating conditions of the cardboard-sheet manufacturing apparatus and manufacturing conditions of the cardboard sheet, depending on current operating conditions of the cardboard-sheet manufacturing apparatus, current manufacturing conditions of the cardboard sheet, and current environmental conditions.

8. The controlling system according to claim 1, further comprising:
an image capturing unit that captures an image of the cardboard sheet manufactured to acquire a condition of the cardboard sheet, wherein
the information on evaluation of the cardboard sheet manufactured is created based on the condition of the cardboard sheet acquired by the imaging unit.

9. The controlling system according to claim 1, further comprising a display unit that displays a condition of the cardboard sheet in process while the cardboard-sheet manufacturing apparatus is in operation.
